(19) United States
(12) Patent Application Publication
(10) Pub. No.: US 2002/0147733 A1
(43) Pub. Date: Oct. 10, 2002

(54) Quota management in client side data storage back-up

(75) Inventors: Stephen Gold, Bristol (GB); Peter Thomas Camble, Bristol (GB)

Correspondence Address: IP Administration, C/o Hewlett-Packard Company, 3404 East Harmony Road, Mailstop 35, Fort Collins, CO, 80528-9599, US

(73) Assignee: Hewlett-Packard Company

(21) Appl. No.: 09/826,811

(22) Filed: Apr. 6, 2001

(51) Int. Cl. G06F 12/00

(52) U.S. Cl. 707/200

(57) ABSTRACT

There is disclosed a method of managing backed up data storage region of a plurality of client computers, enforced by a client side agent, and based upon a total of files stored within a client back up data storage region A total file size of current files stored at the client computer is compared to a first soft back up quota limit, at which a warning message is displayed, and a second, hard back up limit, at which back up of client files to a back up computer is prohibited. Quota limits can be set centrally from a back up computer, and deployed to each of the plurality of client computers served by a back up computer. Elimination of backed up file duplication is made at the back up computer, by use of a database and pointers to common files for a plurality of computers.

### FIELD OF THE INVENTION

The present invention relates to the field of data storage back-up of computers.

### BACKGROUND TO THE INVENTION

In a conventional client-server based computer network having a plurality of client computers, and one or more server computer entities, each client computer entity may rely on one or more servers for core functionality including applications, and data storage. However, each client computer entity is typically provided with a local data storage device, such as a hard disk drive. The amount of data which can be stored locally on each client computer is significant, and with trends to decreasing cost of hard drive data storage and increasing volumes of hard drive data storage provided on client computers, data storage capacities of 10 GigaBytes or above at a client computer are common.

For relatively small numbers of client computers, typically up to 25 or 100 client computers, significant amounts of management of back-up of client data is not required. However, for larger numbers of client computers, handling client data back-up becomes difficult without a client back-up management scheme in place. The amount of data which individual client computers can store in a backup area needs to be limited to avoid inefficient use of back-up resources. Typically, the overall purchase cost of a prior art back-up computer constitutes approximately 10% of the overall lifecycle cost of running the back-up capacity provided by the back-up computer, with the other costs being maintenance cost and administration cost.

Traditional server based quota management schemes total up a size of all files or other application data entities, for example emails, which are stored on a server, and which are associated with a user. Prior art email server systems have data storage back-up quota management systems for limiting the amount of emails each of a plurality of client computers can store. In these systems, a warning is sent to a user if the amount of data which they can store is likely to be exceeded. Typically, in such prior art systems, there is a “soft” limit at which a warning to a client computer is generated, and a “hard” capacity limit at which point further storage of data is disallowed. For email servers, the capacity quota limits usually prevent users from sending any emails, but still allow users to continue to receive emails.

This works well for the traditional file servers and email servers, including those with a single instance file store, as totaling up all the users' unique data and common files provides a direct measurement of disk usage that the user can relate to as providing a level of service.

The known Windows 2000® operating system has a quota management facility for allowing quotas of back-up data storage space to each of a plurality of client computers. With the Windows 2000® file server product, the quota management system prevents users adding more data, but still allows users to read their existing stored data on the file server.

In prior art client delta back-up systems, there is not a direct correlation between the amount of file data a user thinks they are using and quota calculations performed by a server computer. Using prior art server based quota techniques, an apparent level of service which a client user sees does not relate well to summation calculations which a quota system performs. For example, if a user performs a series of edits to a file, resulting in a smaller file size, the user would expect that their quota usage would decrease. However, in prior art systems, because the server tracks these changes, and requires more disk space to store the changed information, the users quota usage actually increases. From a user perspective, this makes it almost impossible to understand a client back-up quota system, and is likely to result in the user unsuspectingly using up all their quota back-up storage capacity as well as creating data storage management problems for a human administrator of the system, directly contrary to the whole objective of implementing the quota system in the first place.

In prior art systems, there is not a direct correlation between the amount of available back-up data storage space to a client computer user, and the amount of data storage space which the client computer user thinks that they have available.

### SUMMARY OF THE INVENTION

Specific implementations according to the present invention store multiple versions of files, with delta blocks, on a server device where the delta blocks represent changes between each revision of a file. In addition, deleted files on a client side are kept on a server device for a specified period of time before being removed from the server device.

One object of specific implementations according to the present invention is to provide a client computer user with an easily understandable back-up facility for client computer storage space, which appears logical and simple to use from the client computer users point of view. For example, if a user stores 100 MegaBytes of data on their client computer local data storage, and their back-up limit is 110 MegaBytes, then the user should be aware that the back-up limit is being approached. Similarly, if the client computer user reduces a file size, so that a newly stored file of 50 MegaBytes replaces a previous file of 100 MegaBytes in the client computer local data storage space, the amount of available back-up space, should allow the user another 60 MegaBytes or so until the hard limit is reached.

The specific implementations total only size of the latest versions of files on a user system that have been sent to the server device.

According to a first aspect of the present invention there is provided a back up method for a plurality of computers, said plurality of computers comprising:

a back up computer device, said back up computer device comprising a data processor, a communications link for communicating with other said computers, and a bulk data storage device for storing back up data of said other computers;

a plurality of client computers, each said client computer comprising at least one data processor, and a data storage device having a client data storage area,

wherein said back up computer operates to back up data stored in said client data storage areas of each of said plurality of client computers, said method comprising the steps of:

maintaining a list of files on a said client computer allocated for back up;;

maintaining a total size data describing a size of each said listed file;

determining a total file size data describing a total size of said listed files of said client computer;

comparing said total file size data with a predetermined size limit; and

determining whether to back up said client files or not, depending on a result of said comparison between said total file size data, and said predetermined size limit.

According to a second aspect of the present invention there is provided a method of storing back up data of a plurality of client computers, on a back up computer, said method comprising the steps of:

receiving a first file set from a first said client computer;

storing said first file set on said back up computer;

maintaining a database entry describing said first file set;

receiving a second file set from a second said client computer;

comparing said second file set of said second client computer with said first file set of said first client computer;

for any files of said second file set which are identical to individual files of said first file set, allocating in said database pointers to data locations of said common files already stored; and

storing said files of said second file set which are not identical to files of said first file set in said back up computer.

According to a third aspect of the present invention there is provided a method of operating a back up computer, said back up computer comprising:

at least one data processor;

a data storage device for storing a plurality of back up files;

an interface device; and

a back up management application for managing storage of data in said data storage device;

said method comprising steps of:

allocating a plurality of back up data storage areas, for storing data received from each of a plurality of client computers;

receiving a total file size data from each of a plurality of client computers, each said total file size data representing a total file size at said client computer of files backed up to said back up computer; and

for each said client computer, transmitting to said client computer a file size limit representing a limit of total file size on each said client computer, for which back up of said files is permitted.

According to a fourth aspect of the present invention there is provided a method of operating a client computer, said client computer comprising;

at least one data processor;

a data storage device for storing client files, said data storage device having a backed-up data storage area from which files may be sent for back-up;

an interface device; and

a back-up management agent for managing back-up of data from said backed-up data storage area;

said method comprising the steps of:

creating a list of files resident in said backed-up data storage area;

for each said file on said list, storing a size data describing a size of said client file;

summing said plurality of file sizes to obtain a summed file size total; and

comparing said summed file size total with a size quota limit.

According to a fifth aspect of the present invention there is provided a client computer comprising:

a data processor,

a data storage device having a data storage area reserved for files which are subject to a back-up process;

an interface device; and

a back-up management agent which operates to manage back-up of files in said backed-up data storage area by sending said files via said interface device.

According to a sixth aspect of the present invention there is provided a method of performing back-up of data on a plurality of client computers to a back-up computer, said method comprising the steps of:

for each said client computer:

each time a back-up operation of said client computer is initiated, determining a total size of all files of said client computer to be backed up, and determining whether performance of said back-up would cause a first predetermined quota limit to be exceeded;

determining if performance of said back-up would cause a second predetermined quota limit to be exceeded;

if it is determined that performance of said back up would cause said first predetermined quota limit to be exceeded, but said second predetermined quota limit not to be exceeded, then proceeding with said back-up, and generating a warning signal warning that said first predetermined quota limit is exceeded;

if performance of said back-up would exceed said second predetermined quota limit, then prohibiting said back-up, and generating a warning signal that said second predetermined quota limit would be exceeded.

According to a seventh aspect of the present invention there is provided a method of operating a client computer, said client computer comprising;

a data storage device for storing client files, said data storage device having a back-up data storage area from which files may be sent for back-up; and

a back-up management agent for managing back-up of data from said backed up data storage area;

said method comprising the steps of:

upon initiation of a back-up process;

maintaining a quota list, said quota list comprising a list of files in said backed-up area, which were backed up during a previous back-up operation;

performing a back-up operation on said files stored in said backed up data storage area;

after said back-up operation, modifying said copy quota list to list a plurality of files actually backed up by said back-up operation.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a system of computers comprising a plurality of client computers, at least one back up computer, and at least one management console computer, implementing a client side back up quota limit system according to a first specific implementation of the present invention;

FIG. 2 illustrates schematically in perspective view a data back up computer comprising the system of FIG. 1;

FIG. 3 illustrates schematically components of the back up computer of FIG. 2;

FIG. 4 illustrates schematically a partition structure of a RAID array of the back up computer of FIG. 2;

FIG. 5 illustrates schematically a logical view of the back up computer and a plurality of client computers, each having an agent corresponding with a back up application on the back up computer;

FIGS. 6-8 illustrate schematically transfers of file data from first to third client computers respectively to the back up computer in an operation of the system of FIG. 1;

FIG. 9 illustrates schematically transfers of files from a single client computer to the back up computer, according to a second operation of the system of FIG. 1;

FIG. 10 illustrates schematically division of data storage space on a plurality of client computers, into backed up regions, which are backed up onto the back up computer;

FIG. 11 illustrates schematically management of backed up files over a period including a succession of back up operations, at a client computer;

FIG. 12 illustrates schematically management of a quota utilization parameter over a succession of back up operations by the client back up agent at a client computer device;

FIG. 13 illustrates schematically logical components and their interaction between a client computer and the back up computer for setting policies on allowed client data storage to be backed up to a back up computer, and for implementing those policies;

FIG. 14 illustrates schematically processes carried out by a client agent within the client computer for managing a quota list and a difference list, to manage an amount of allowed utilization of data storage space in a backed up region of a client computer;

FIG. 15 illustrates schematically creation of a difference list at the client computer from a quota list and a new list of backed up data, by a quota list management process carried out by the client agent;

FIG. 16 illustrates schematically partition of a data storage area of a client computer into a non-backed up region and a backed up region;

FIG. 17 illustrates schematically an error procedure for creating a new quota list from a difference list and an existing quota list; and

FIG. 18 illustrates schematically interaction between a client agent on a client computer and the back up computer for setting policies, and informing the back up computer of current utilization of quota limits applicable to the client computer.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

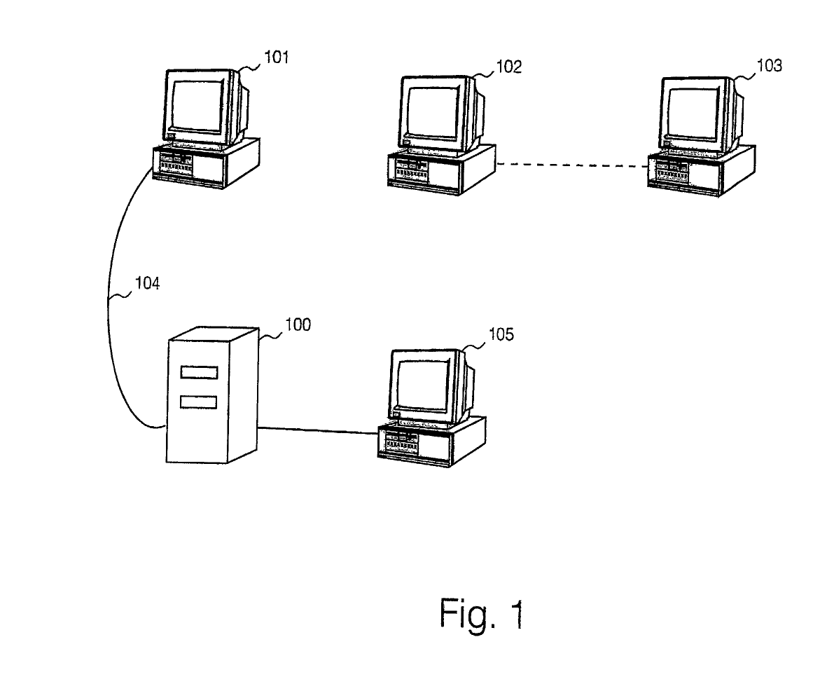

Referring to FIG. 1 herein, there is illustrated schematically a deployment of a data storage back-up server device 100, connected to a plurality of client computers 101-103 over a network connection 104, the data storage back-up device being viewable via a management console computer 105 for administration and management purposes.

An administrator using the management console computer 105 manages back-up disk space for individual hard drives on each of the plurality of client computers. Due to the high number of client computers in the network, the administrator needs to apply relatively strict control to the amount of back-up data storage available to each client computer, to encourage users of client computers not to store unnecessary data on the local hard disk drives of the client computers, bearing in mind that there is an associated cost of ownership of the data storage back-up computer 100, and administration costs involved in performing client computer back-ups.

In a small deployment of client computers, say for example 10 or 20 client computers, an administrator can personally browse each client computer and inspect the amount of client computer hard drive in use for non-server applications and data storage, and manage back-up of the client computer data storage space. However, in larger networks, having upwards of 100-200 computers, this task becomes unmanageable for an administrator, and an automatic mechanism for client computer data storage back-up becomes necessary.

The best mode embodiment seeks to limit the amount of data which can be backed-up per client computer, whilst providing a quality of service measurement to each client computer user.

An object is to provide each client computer user with a usable working space on the client computer which is backed-up, but without allowing excessive storage of unnecessary data which is backed-up. Therefore, users of client computers can be sure of back-up of their important data, such as emails and the like, but other data resident on the hard drives of a client computer which exceeds the limit which is backed-up, will not be backed-up on the back-up computer 100.

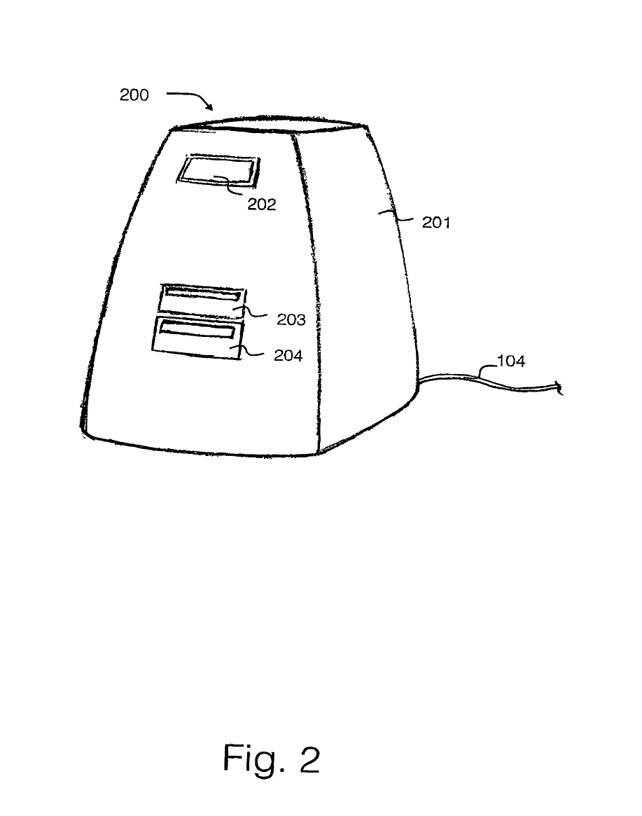

Referring to FIG. 2 herein, the headless computer entity 200 comprises a casing 201 containing a processor, memory; data storage device, e.g. hard disk drive; a communications port connectable to a local area network cable; a small display on the casing, for example a liquid crystal display (LCD) 202, giving limited information on the status of the device, for example power on/off or standby modes, or other modes of operation. Optionally a CD-ROM drive 203 and optionally a back-up tape storage device 204. Otherwise, the headless computer entity has no physical user interface, and is self-maintaining when in operation. Direct human intervention with the headless computer entity is restricted by the lack of physical user interface. In operation, the headless computer entity is self-managing and self-maintaining.

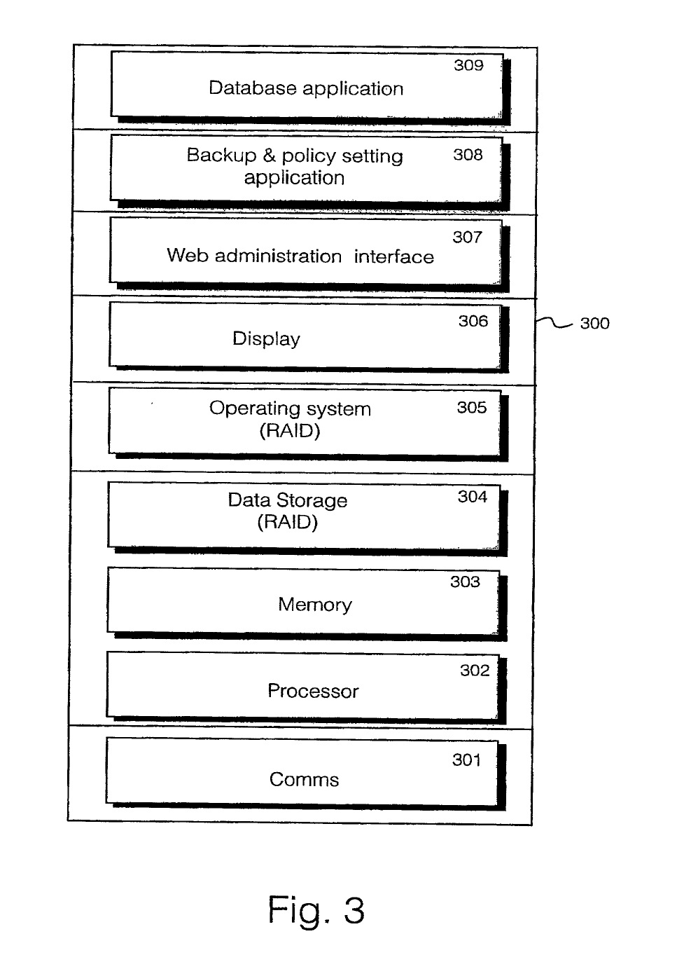

Referring to FIG. 3 herein, there is illustrated schematically physical and logical components of the headless server computer entity 300. The computer entity comprises a communications interface 301, for example a local area network card such as an Ethernet card; a data processor 302, for example an Intel® Pentium or similar Processor; a memory 303, a data storage device 304, in the best mode herein an array of individual disk drives in a RAID (redundant array of inexpensive disks) configuration; an operating system 305, for example the known Windows 2000®, Windows95, Windows98, Unix, or Linux operating systems or the like; a display 306, such as an LCD display; a web administration interface 307 by means of which information describing the status of the computer entity can be communicated to a remote display; an application back up and policy setting module 308 in the form of an application, for managing the amount of back-up data storage allocated to each client; a database application 309.

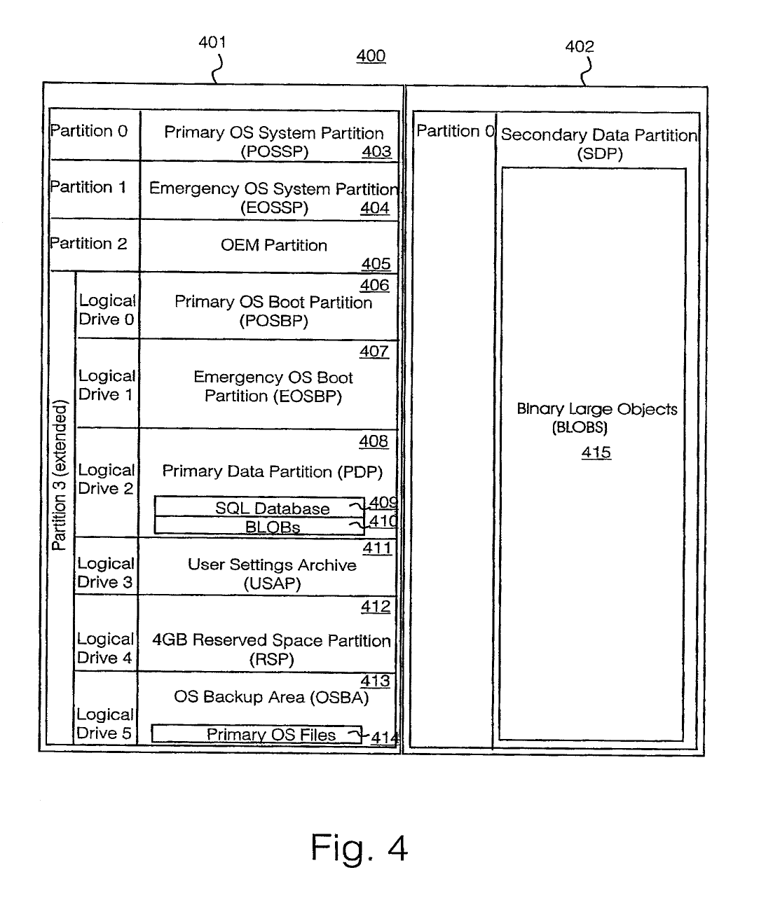

Referring to FIG. 4 herein, there is illustrated schematically a partition format of a headless computer entity, upon which one or more operating system(s) are stored. Typically, the data storage device in data storage back-up computer 100 comprises a large RAID array partitioned as illustrated in FIG. 4. Data storage device 304 is partitioned into a logical data storage area which is divided into a plurality of partitions and sub-partitions according to the architecture shown. A main division into a primary partition 401 and a secondary partition 402 is made. Within the primary partition are a plurality of sub partitions including a primary operating system partition 403 (POSSP), containing a primary operating system of the computer entity; an emergency operating system partition 404 (EOSSP) containing an emergency operating system under which the computer entity operates under conditions where the primary operating system is inactive or is deactivated; an OEM partition 405; a primary operating system boot partition 406 (POSBP), from which the primary operating system is booted or rebooted; an emergency operating system boot partition 407 (EOSBP), from which the emergency operating system is booted; a primary data partition 408 (PDP) containing an SQL database 409, and a plurality of binary large objects 410, (BLOBs); a user settings archive partition 411 (USAP); a reserved space partition 412 (RSP) typically having a capacity of the order of 4 gigabytes or more; and an operating system back up area 413 (OSBA) containing a back up copy of the primary operating system files 414. The secondary data partition 402 comprises a plurality of binary large objects 415.

In the best mode embodiments, there is totaled only the size of a latest version of files on a users system that have been sent to a server. For example, if a user has only ever backed-up one directory on their client computer, it is the current size of those files in that directory on the users client computer that is used to represent a quota usage for that user. This may be calculated on the server device, but with RFE, delta blocking and prior art compression techniques used to reduce disk storage space on the server device.

In the prior art solutions, this requires a complex and probably low performance solution at the server device.

On the other hand, specific implementations of the present invention use a back-up agent installed on the client's computer to calculate a quota usage of the user and implement a quota policy based on server or agent settings. The server or agent can then use this information to implement quota policies, for example to warn a user when they approach near their quota limit, and block further back-ups once a quota limit has been reached.

In one implementation, an agent calculates a user quotage usage using a method as follows:

An agent keeps a running log on a client computer of the latest versions of all files that have been sent to the server computer for back-up since the agent was installed, and that still exist on the client, that is to say which have not been deleted. This includes file size information and the total size of all files.

On each back-up operation, be it a partial back-up of selected files, or a full back-up of a whole system, either automatically scheduled or manually initiated by a user, the agent scans each disk volume and folder, and any sub-folders selected for back-up (after an exclusion list has been applied), and creates a new difference log data representing the latest state of all files in the selected directory hierarchies.

The agent then compares the running log and the difference log. Starting with total file size entry from the running log:

For each file selected for back-up if that file entry exists in the differences log but not in the running log, then the file must be new and therefore the file size as marked in the differences log will be added to the new total file size. If a file entry exists in the differences log and in the running log, the file may have changed, so the size of the file as marked in the running log will be deducted from the new total file size and the file size as marked in the differences log will be added to the new total file size.

For each folder selected for back-up, including a root folder if a drive is selected:

If that folder entry exists in the differences log but not in the running log then the folder is new, and the size of all files in that folder as marked in the difference log will be added to the new total file size. Otherwise, that folder must have been backed-up previously, so all file entries for that folder will be compared in the running and difference logs. If a file in that folder exists in the differences log but not in the running log, then the file has been added to the folder and it's file size is added to the new total file size. If a file in the folder exists in the running log but not in the differences log, then the file has been deleted and it's file size is deducted from the new total file size If a file in the folder exists in both the running log and the differences log, then the file may have changed size, so the size of the file as marked in the running log will be deducted from the new total file size and the file size as marked in the differences log will be added to the new total file size.

The above step is recursively repeated for all sub-folders of the selected folders.

The new total file size can then be compared by the agent against a warning quota limit and a hard quota limit for a particular client computer, where the warning limit and hard quota limits are obtained from the server computer. The agent can then implement a quota policy, for example to warn a user when they approach a quota limit and block further back-ups once the quota limit has been reached.

In a best mode implementation the server computer keeps global quota settings and a list of override settings for individual client computers. If the quota limit has been reached or exceeded, back-up operations will not start, and a previous log file will be maintained intact. If a quota limit has not been reached, changed file data, added file data and deleted file data from the difference log, and the new total file size will be merged into the running log.

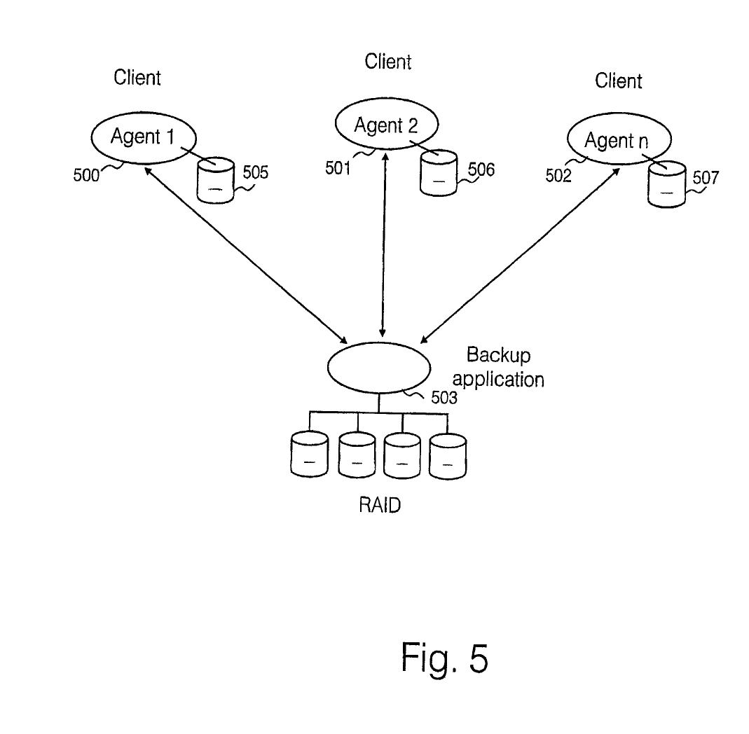

Referring to FIG. 5 herein, there is illustrated schematically logical components of a client computer back-up data storage system according to the specific implementation of the present invention. Each client computer has a software agent 500-502 which communicates with a back-up application 503 resident on a back-up data storage device, the back-up application 503 allocating quotas of back-up data storage space in a RAID array 504 of the back-up data storage device, such that each local hard drive 505-507 on the client computers are allocated a corresponding respective amount of back-up data storage space, which is managed by the corresponding agent on each client computer.

The agent can be part of the operating system of a client computer, or can be a separate application running on top of the client computer operating system.

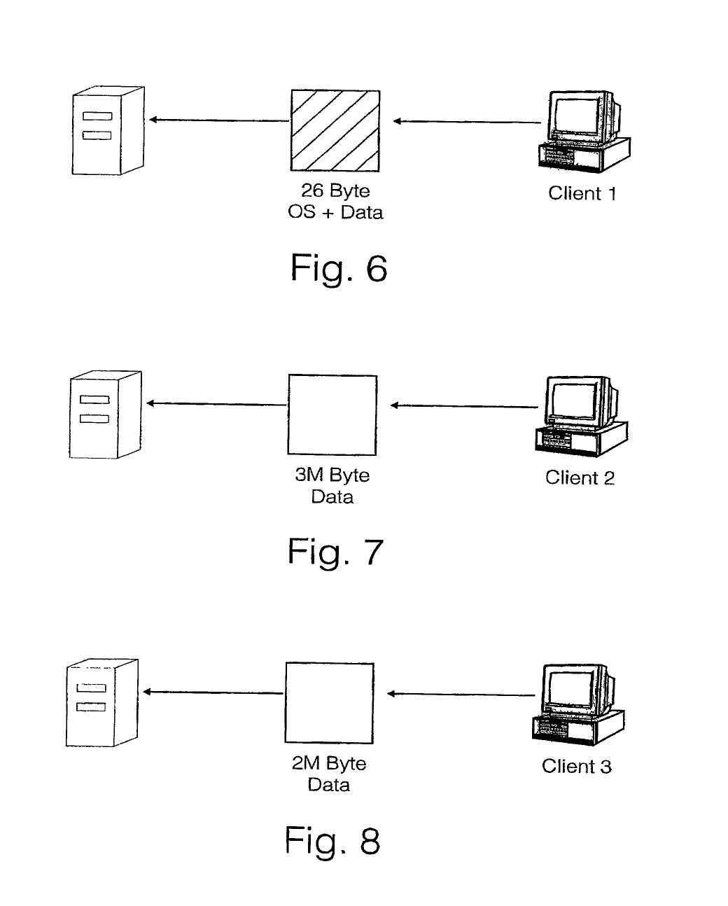

Referring to FIG. 6 herein, there is illustrated schematically a complete backup of a first client computer data storage device is made, and stored on the backs up device.

The first time any client computer backs-up onto the data storage computer, all of the data in the client hard disk is backed-up, including, for example an operating system and data.

As the next computer (client 2) is backed-up, the first time this computer is backed-up any data or applications on the data storage space of that computer which are different from those of the first client computer are backed-up onto the back-up device. Files which are common to the first and second computers are not backed-up for the second computer, but a pointer to the appropriate place on the back-up devices storage is made. Therefore, only data and/or applications on the second client computer which differ from those on the first client computer are sent across the network and stored on the back-up device as illustrated schematically in FIG. 7.

Referring to FIG. 8 herein, for a third computer, any files on the third computers data storage space which are not common to the first and second computers are backed-up on the back-up computer. However, any common files, for example a common operating system, are not stored separately for the third computer, but rather a pointer to the operating system stored for the first computer is stored in a back-up data storage space allocated to the third computer.

For each successive computer, for identical data or applications stored for that computer which are identically common to data or applications stored for other client computers, a pointer is used to the previously stored application or data for the other computer. Consequently, in the back-up data storage space, only difference data, that is data which differs from client computer to client computer is stored. Any common data which is the same for all client computers is stored only once, with pointers being stored to that data indicating that other client computers use that data in common.

A database in the back-up device stores the pointer data, to track where any common files are stored on the back-up device, where fragments of files are stored, and which client computer owns which fragment or data file.

When a client computer retrieves data from the back-up device, the agent queries the database and the database produces a list of all files and fragments available to the client computer.

Subsequent back-up operations for each client computer are implemented by delta back-ups. As files change on the client computer, only the delta files are sent to the back-up device. The delta files are files which contain instructions for changes made to the file.

Therefore, for each client computer, after a series of successive client computer back-ups to the back-up device, the data stored on the back-up device, if inspected would comprise: a baseline back-up, being the initial first backed-up files of the client computer, which may include pointers to other files stored for other computers, where those files are common between different client computers, thereby having redundant files eliminated from the baseline back-up; and a plurality of delta back-up files for each client computer.

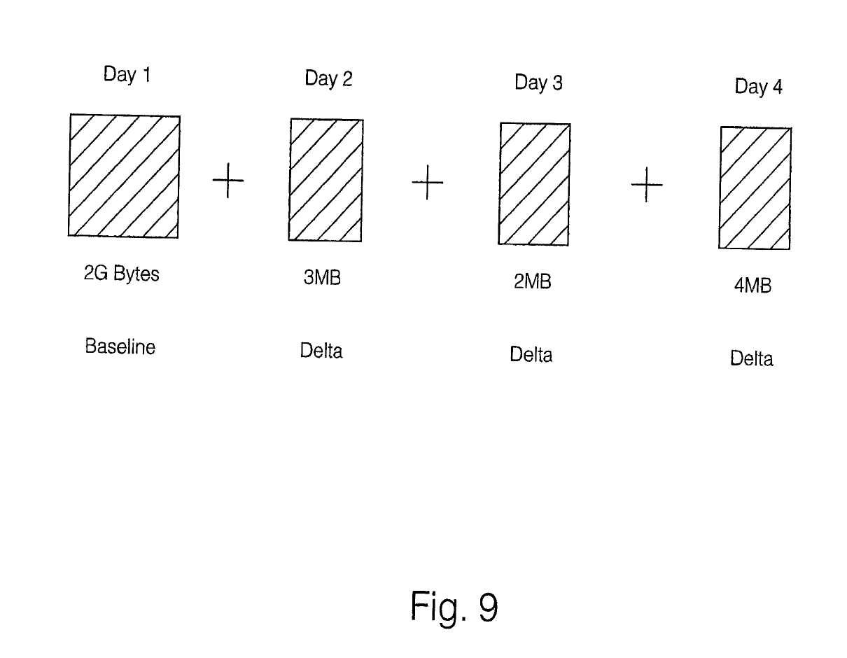

Referring to FIG. 9 herein, there is illustrated schematically a typical back-up sequence from a client computer to the back-up computer over a period of days. On the first day, a full baseline data back-up may be made as described herein above, where all data from the client computer data storage is stored on the back-up device, with elimination of redundant files appearing on other client computers at the back-up device. The initial baseline back-up may be relatively large, for example 1 or 2 GigaBytes. On a second day, a delta back-up may occur, including any files changed on that day on the client computer. File size may be typically 3 MegaBytes or so. On the third and fourth and subsequent days, further delta back-ups are made sent from the client computer to the back-up computer. Delta back-up technology is well known in the prior art, with companies such as Previo, Connected Corporation, Storactive Corporation, Veritas, and Live Vault, all operating known delta back-up technology.

Consequently, from the users perspective at the client computer the user may know on each day how much data has been sent to the back-up device for back-up. However, this does not necessarily bear any easily discernable relationship from the client computer users point of view, to the actual amount of back-up data storage capacity used by that client computer at the back-up device, because file elimination may have taken place. Therefore, in the present implementations, there are the features that:

A quota scheme looks at data on a client computer, rather than on a back-up device;

The back up computer stores history data, in order to maintain quality of service to the client computer, enabling user of the client computer to obtain historical back-ups.

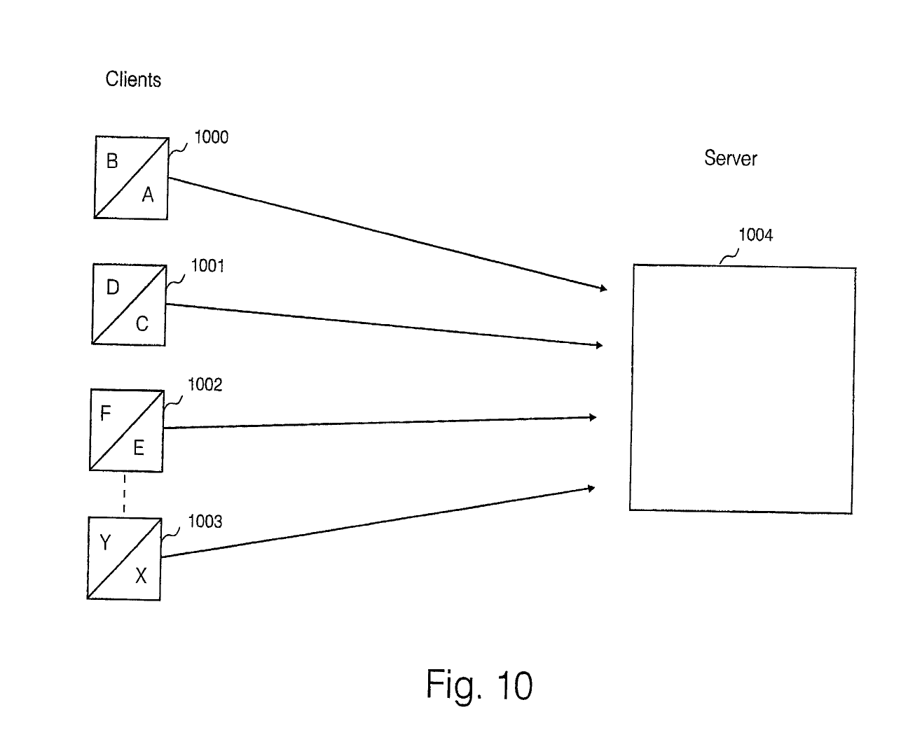

Referring to FIG. 10 herein, there is illustrated schematically data storage devices 1000-1003 of a plurality of client computers, each partitioned into a first data storage area B, D, S, Y respectively which is not backed-up to a back-up computer 1004, and a second data storage area A, C, E, X respectively, which is backed-up to the back-up computer 1004. The back-up computer 1004 receives back-up data from each of the backed-up data storage areas of the plurality of client computers.

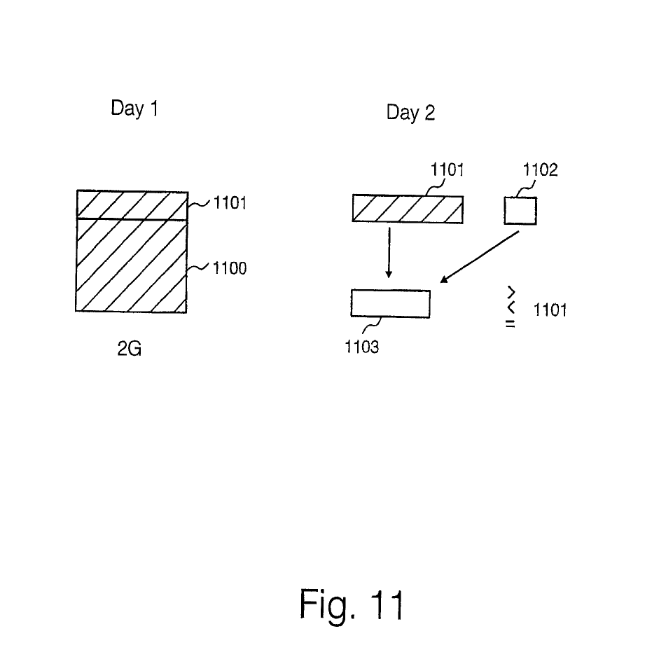

Referring to FIG. 11 herein, there is illustrated schematically back-up of part of a backed-up area of a client computer data storage device on successive days. On a first day, the whole data storage area 1100 of the client data storage device may be sent to the back-up computer for back-up. The back-up computer may compare individual files sent over with individual files of other client computers, and check for commonality to see if the received files are identical to files already existing for other client computers which are backed-up on the back-up computer. The back-up computer stores the files, or stores pointers to other existing files as appropriate, depending upon whether the files are new files, or whether they are the same as existing files already backed-up on the back-up computer.

On a second, subsequent day, changes are made to the files on the client computer, resulting in changed files 1101. On a next back-up operation, typically activated on the second, subsequent day, but alternatively implemented in response to a request from either the back-up computer or the client computer to initiate a back-up operation, the changed delta files received by the back-up computer are compared with the existing files and either stored, or a pointer to an existing identical delta file is stored depending upon the selection of files already stored on the back-up computer. The back-up computer assesses the size of a file which would result from a previously received client file, plus it's delta back-up file. That is to say, the back-up computer estimates the size of the file actually resident on the client computer from the size of the previously received client file, plus it's delta back-up. The data actually stored on the back-up computer is the existing original file, plus it's delta back-up file, which may be a larger number of bits than the changed file stored on the client computer. However, for the purposes of determining the allowable utilized back-up data storage from the client computer, the size of the client files actually resident in the client computer backed-up area is used, rather than the amount of actual back-up data storage capacity used on the back-up computer for that client computer. As shown in FIG. 11, the resultant client file 1103 can have a size which is either less than, equal to, or greater than the combination of the original client file stored on the back-up computer, plus it's delta back-up file (s).

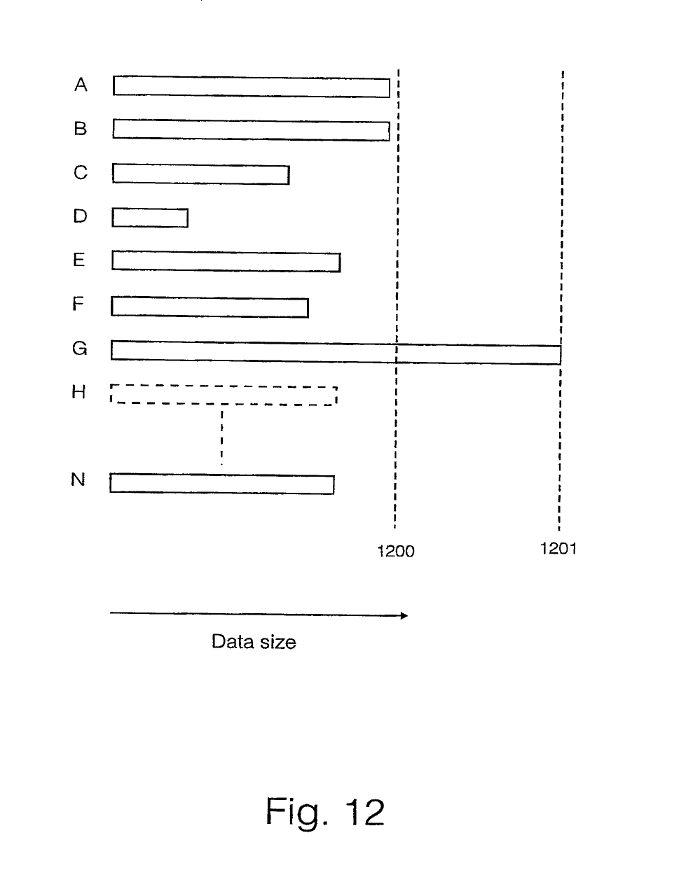

Referring to FIG. 12 herein, there is illustrated schematically, for a single client computer, a succession of file back-up data storage space utilization's of the client computer in relation to a soft quota limit 1200, the reaching of which activates a warning to a client computer user, and a hard quota limit 1201, the reaching of which activates denial of back-up service from the back-up computer for that client computer.

As seen schematically in FIG. 12, on successive back-up operations A-H . . . M, the utilization of the allowable back-up data storage quotas varies depending upon how many files are stored in the client back-up data storage area. As the size of backed-up files fluctuates, the soft and/or hard limits may or may not be reached. The hard and soft quota limits can be set by an administrator via a user console communicating with the back-up computer via it's web interface. The hard and soft quota limits can be set individually to be different for each client computer, or can be set en masse to be the same for a set of a plurality of different client computers all backing-up to a single back-up computer. Quota policies can be set across a plurality of aggregated computers.

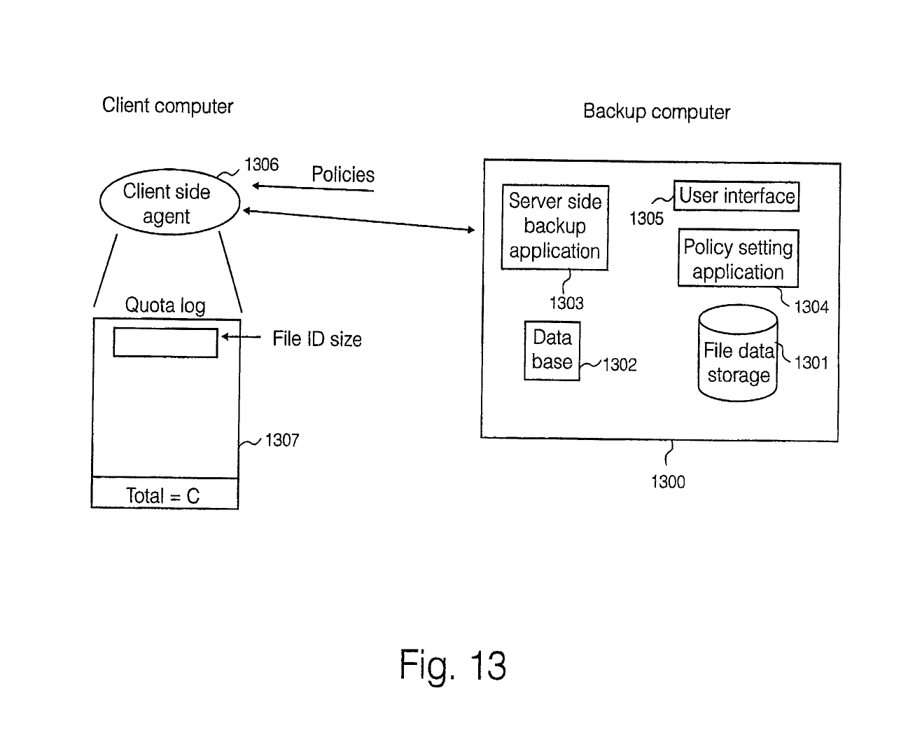

Referring to FIG. 13 herein, there is illustrated schematically communication between a back-up computer and a single client computer having a client side agent, for implementation of quota management policies transmitted from the server back-up computer.

The server side back up application is responsible for communicating with the client side agents, for tracking all data which it receives, and for reconstructing back-up data files which it has stored for clients, in response to requests for back-up data from client computers. The server side back up application allocates incoming delta files to data storage space within the file data storage 1301, and keeps a record of which client computer the incoming delta files are related to, a time and date when the delta file was received, and a record of where the delta file is stored on the file data storage 1301. The database 1302, may be implemented in SQL server for example.

An administrator can actively monitor the current configuration of back-ups using the web administration interface and the headed computer console.

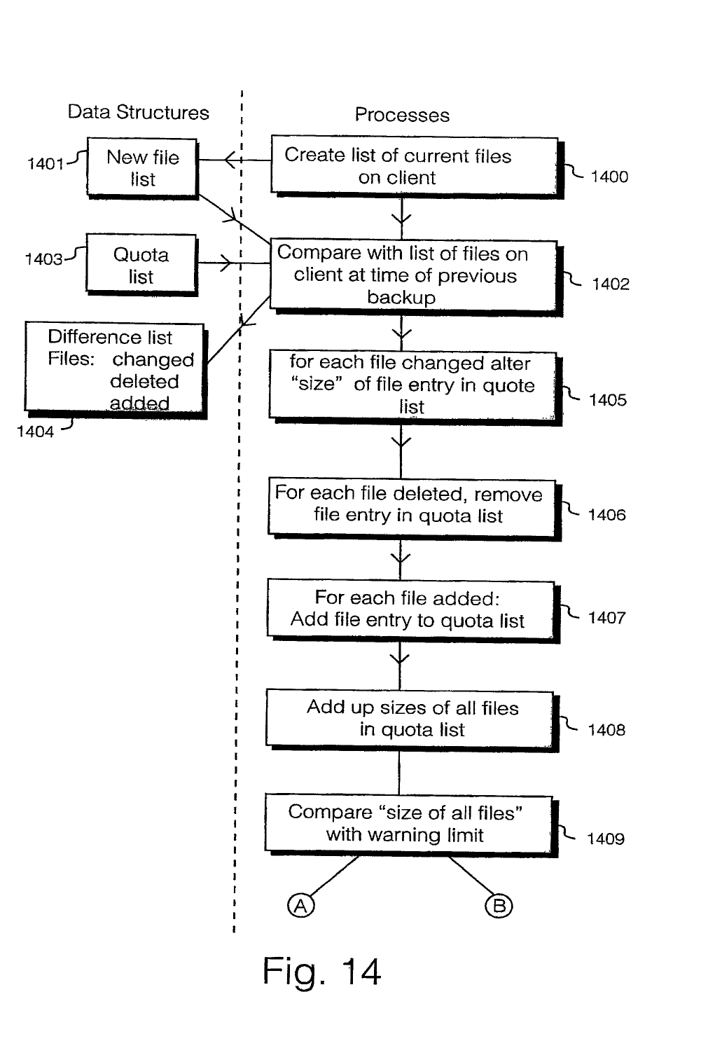

Referring to FIG. 14 herein, there is illustrated schematically processes carried out by the client agents and server side back up application for managing back up quotas.

Each time a back-up is initiated, a check is made to see if performing the back-up will cause any of the quota limits to be exceeded. This is done by calculating a quota list and a total file size of all files on the quota list If the soft quota limit is exceeded, but the hard quota limit is not exceeded then the back-up will proceed. The user will be warned that they have exceeded their soft quota limit, and the system administrator will be able to see via the administration console that the back-up account has exceeded its soft quota limit. If the hard quota limit is exceeded, the back-up will not proceed, and the user will be informed that they have exceeded their hard quota limit and that back-up cannot proceed. The administrator will be able to see via the administration console that the back-up account has exceeded its hard quota limit and that back-up has not proceeded for that particular client computer.

In step 1400, the client creates a list of current files on the client computer, resulting in a new file list 1401. In step 1402, a quota list 1403 is compared with the new file list 1401. This compares the list of current files on the client with the list of files on the client at the time of the previous back up and produces a difference list 1404 which lists files changed, files deleted and files added since the last back-up operation. In step 1405, for each file changed, a size data entry in the quota list is altered, so that the quota list has an up to date total size of data for all files in the client computer backed up region. In step 1406, for each file on the client computer which is being deleted since the last back up, the file entry in the quota list is removed. In step 1407, for each file added in the client backed up area, since the last back up, a file entry is added to the quota list. In step 1408 the sizes of all the files in the quota list are added to obtain a file size total. In step 1409, the agent compares the total size of all the files on the quota list with a “soft” warning limit. If the total size of all files in the current quota list is smaller than the warning limit size, then in step 1410, the client agent proceeds with a client back up, either in response to a predetermined clock signal to back-up at a regular time, or in response to a user input, or in response to a signal from the server side back-up application. In step 1411, once the back-up is made, the client agent recalculates the quota list to only involve files which are actually backed up onto the back-up computer. This recalculated quota list represents the client computers utilized back-up space within the hard and soft back up quota limits, and is viewable by a user of the client computer, so that the user can see how much back up space is still available.

However, if in step 1409 the total size of all files is higher than the soft warning limit, then in step 1412 the client agent compares the size of all the files in the client backed-up region, with the hard limit, beyond which back ups will not occur. If the total file size is greater than the soft limit, but lower than the hard limit, then in step 1413, the client agent generates a warning message to the user warning that an amount of utilized back-up capacity is over a soft warning limit. This message is displayed to the user on a visual display device of the client computer. The client then proceeds with the client back-up in steps 1410 and 1411 as described previously.

If in step 1412, the total size of all files on the quota list is more than the hard quota limit, then in step 1414, the client agent will not back-up the client backed-up region to the back-up computer, but will send a message to the backup computer alerting an administrator that the client computer has exceeded its back-up quota. A message will also be displayed on the client computer itself alerting the user that client computer back-up is not being carried out and that the hard back-up quota limit is exceeded.

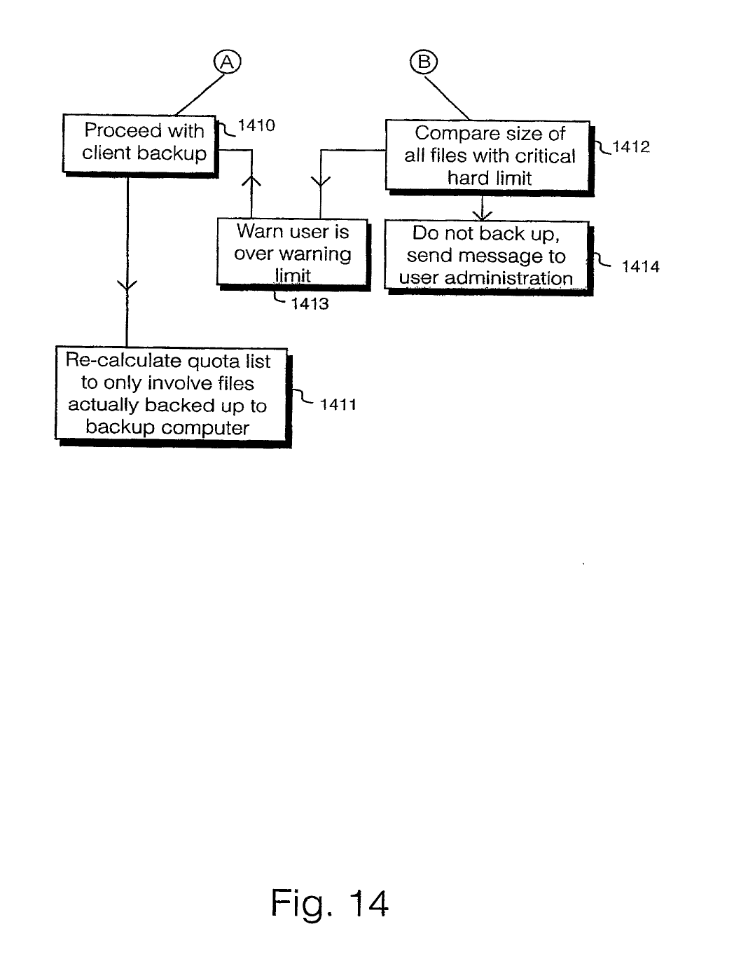

Referring to FIG. 15 herein, there is illustrated schematically processes carried out by the client agent at the client computer for managing back-up data storage. An existing quota list 1500 contains a list of filenames, together with their file sizes. As the files stored on the hard disk space of the client computer change, a new quota list 1501 is generated listing the new files stored on the back-up region of the client computer, since the last back-up. In process 1502, the client agent identifies entries in the quota list which contain files located on folders or partitions selected for back-up. In step 1503 the client agent makes a copy of the quota list 1504 and creates a difference list 1506 in process 1505 listing all the files which are deleted, changed or added between the new list 1502 and the old quota list 1500.

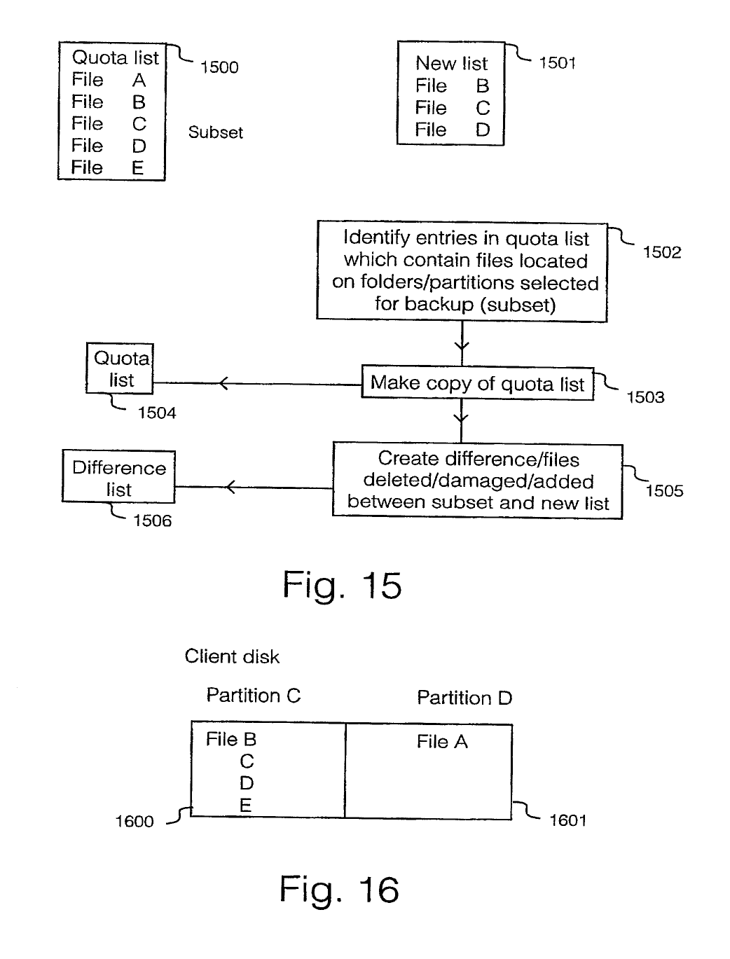

Referring to FIG. 16 herein, there is illustrated schematically partitioning of data on a client hard disk data storage device. The data storage device is divided into a plurality of partitions, each containing files. One or more of the partitions are designated as back-up regions. The quota list and difference list keep a record of files on a backed up partition, for example partition C as shown in FIG. 16.

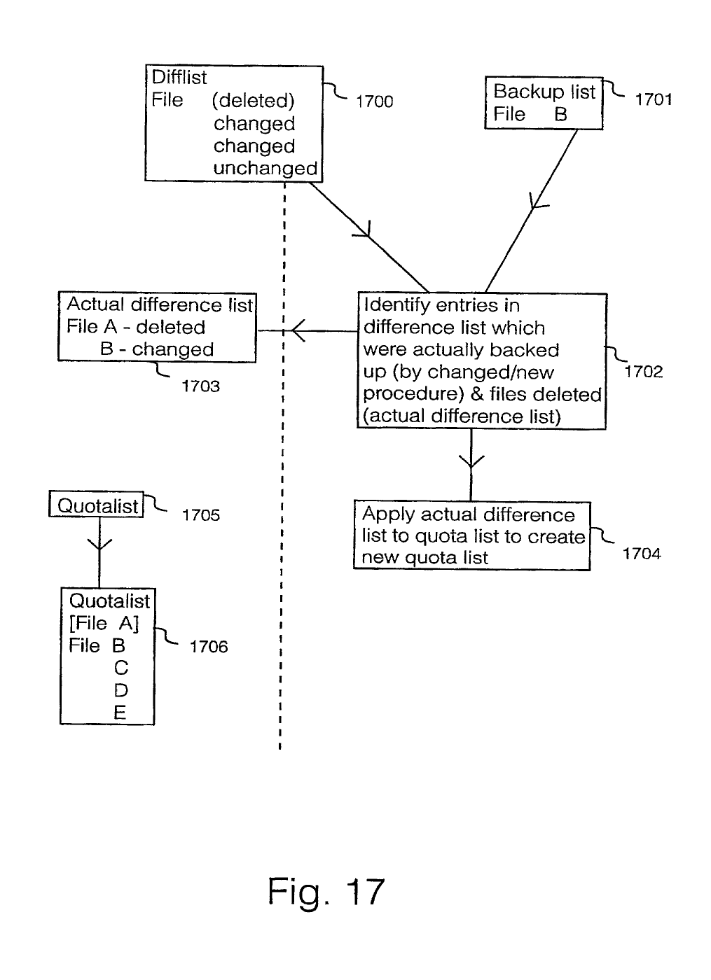

Referring to FIG. 17 herein, there is illustrated schematically processes carried out by the client agent to update the quota list to reflect an accurate record of files currently stored in the backed up region of the client computer.

The quota list is corrected after the back-up, to reflect the data which was actually backed-up. When a back-up is initiated, to see if this back-up would cause the hard or soft quota limits to be exceeded, a difference list 1700 is generated and the quota list 1705 is updated to reflect the situation as it would be at the end of the back-up, as shown in FIG. 14. However, before the quota list is modified, a copy of it is made (as shown in FIG. 15). Once the back-up operation is complete, the copied quota list is modified, using the difference list and a list of files actually backed up, to produce an updated new quota list. During back-up, some files may not have been backed-up for example because a user cancelled the back-up part way through operation, or because a network connection failed, or a file was locked and could not be backed up, or for other reasons. Therefore, there is produced a new quota list which reflects the actual situation after the back-up when the back-up was completed in step 1704. This then becomes the current quota list ready for the next back-up operation, and is used as the basis for making calculations for the next back-up operation.

In step 1700, a difference list 1701, and a backed up list of previously backed-up files 1701 are compared to identify entries in the difference list which were actually backed up previously, and any files deleted. This results in an actual difference list 1703 showing individual files which are deleted, changed, or unchanged from the last back up. In process 1704 the actual difference list is applied to an existing quota list 1705 to modify that quota list and provide a new quota list reflecting the actual status of files in the backed up region of the client computer. Any files shown as deleted on the actual difference list are removed from the quota list, and any files changed or added on the actual difference list are changed or added on the new quota list 1706.

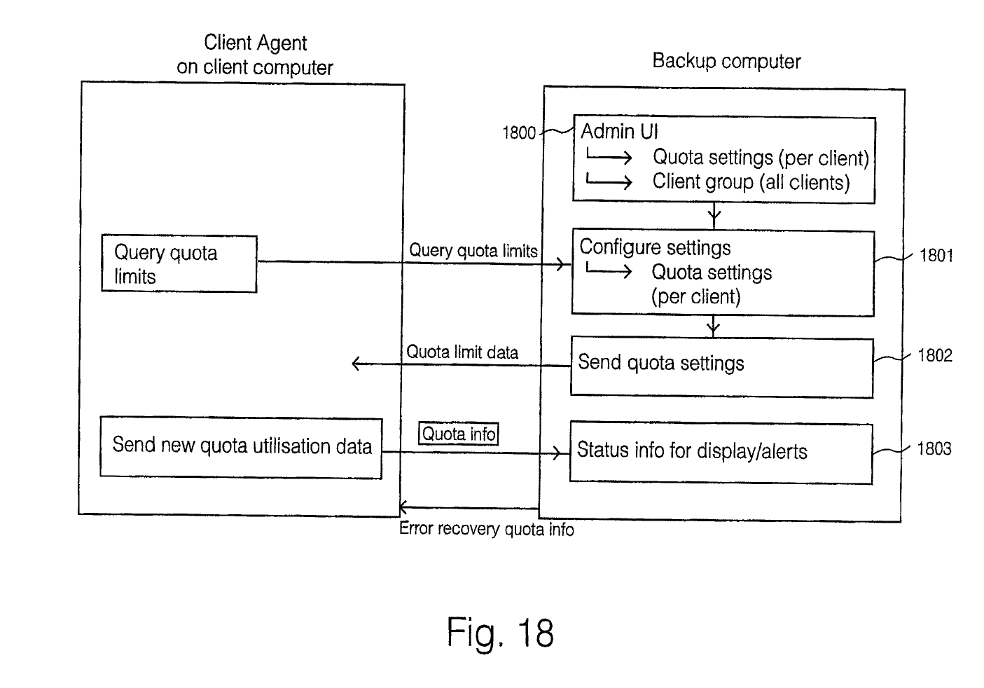

Referring to FIG. 18 herein, there is illustrated schematically interaction between a client agent on a client computer and a back up application 1303 on the back up computer, for setting quota size limits on the client computer. An administrator may set a quota setting per client computer using the administration user interface, accessible via the web administration interface 307. The user is presented with an interactive box dialogue display in which each client computer is listed, along with their current quota settings, including a soft quota limit, being the warning limit at which a warning is presented to a user of a client computer that their back up capacity is about to be exceeded, and a hard quota limit, at which the client agent is disabled from sending back-up data to the back up computer. The user, using the box dialogue display can also set a single generic hard and/or soft quota limit for a group of computers, selected via an interactive display.

In process 1801, the client agent and the client computer can query the configuration settings set by the administrator on the back up computer by sending a query message over the local area network to the back up computer. In response to the received query message, the back up computer sends the quota settings for the particular client computer. In process 1803, as the utilization of allowed back-up storage space changes on the client computer, the client computer can send new quota utilization data to the back up computer, which updates its status information listing the current utilization status of back up data storage device for each client computer on a database at the back up computer, and use that information for display and alerts to the administrator.

1. A back up method for a plurality of computers, said plurality of computers comprising:
a back up computer device, said back up computer device comprising a data processor, a communications link for communicating with other said computers, and a bulk data storage device for storing back up data of said other computers;
a plurality of client computers, each said client computer comprising at least one data processor, and a data storage device having a client data storage area,
wherein said back up computer operates to back up data stored in said client data storage areas of each of said plurality of client computers, said method comprising the steps of:
maintaining a list of files on a said client computer allocated for back up;
maintaining a total size data describing a size of each said listed file;
determining a total file size data describing a total size of said listed files of said client computer;
comparing said total file size data with a predetermined size limit; and
determining whether to back up said client files or not, depending on a result of said comparison between said total file size data, and said predetermined size limit.

2. The method as claimed in claim 1, wherein said step of determining whether or not to back up said client data comprises:
comparing said total file size data with a first file size limit;
if said total file size data exceeds said first file size limit, generating a warning message indicating said first file size limit is exceeded; and
allowing back up of said data files within said file size limit.

3. The method as claimed in claim 1, wherein said step of determining whether or not to back up said client files comprises:
comparing said total file size data with a second file size limit data;
if said total file size data exceeds said second file size limit, then prohibiting back up of said client files.

4. The method as claimed in claim 1, wherein said step of determining whether or not to back up said client files comprises:
comparing said total file size data with a second file size limit data;
if said total file size data exceeds said second file size limit, then prohibiting back up of said client files; and
generating a warning message, that said second file size limit is exceeded.

5. The method as claimed in claim 1 comprising the process of:
maintaining a quota list, listing a plurality of files stored in a backed up region of said client computer, wherein for each said file, there is stored a size data describing a size of said file.

6. The method as claimed in claim 5 further comprising the step of:
for a client computer, summing a total of all said file sizes to obtain a total file size data of files stored in a backed up region of said client computer.

7. The method as claimed in claim 5 further comprising the process of:
for said client computer, storing a difference list, listing differences between files backed up during a previous back up process, and files currently stored in a back up data storage region of said client computer.

8. A method of storing back up data of a plurality of client computers, on a back up computer, said method comprising the steps of:
receiving a first file set from a first said client computer;
storing said first file set on said back up computer;
maintaining a database entry describing said first file set;
receiving a second file set from a second said client computer,
comparing said second file set of said second client computer with said first file set of said first client computer;
for any files of said second file set which are identical to individual files of said first file set, allocating in said database pointers to data locations of said common files already stored; and
storing said files of said second file set which are not identical to files of said first file set in said back up computer.

9. A method of operating a back up computer, said back up computer comprising:
at least one data processor;
a data storage device for storing a plurality of back up files;
an interface device; and
a back up management application for managing storage of data in said data storage device;
said method comprising steps of:
allocating a plurality of back up data storage areas, for storing data received from each of a plurality of client computers;
receiving a total file size data from each of a plurality of client computers, each said total file size data representing a total file size at said client computer of files backed up to said back up computer; and
for each said client computer, transmitting to said client computer a file size limit representing a limit of total file size on each said client computer, for which back up of said files is permitted.

10. A method of operating a client computer, said client computer comprising:
at least one data processor;
a data storage device for storing client files, said data storage device having a backed-up data storage area from which files may be sent for back-up;
an interface device; and
a back-up management agent for managing back-up of data from said backed-up data storage area;
said method comprising the steps of:
creating a list of files resident in said backed-up data storage area;
for each said file on said list, storing a size data describing a size of said client file;
summing said plurality of file sizes to obtain a summed file size total; and
comparing said summed file size total with a size quota limit.

11. The method as claimed in claim 10, wherein said size quota limit comprises a first size limit; and
said method further comprises the step of, if said summed total file size data exceeds said size quota limit, generating a warning message at said client computer, warning that said first quota limit is exceeded.

12. The method as claimed in claim 10, wherein said size quota limit comprises a second quota limit; and
said method further comprises the step of:
if said summed file size data is greater than said second quota limit data, prohibiting back-up of at least one file in said client backed-up data storage area.

13. The method as claimed in claim 10, further comprising the processes of:
comparing the list of said current files on said client backed-up data storage area with a previously generated list of files representing a status of files in said backed-up client area at a previous time; and
identifying files which have changed between said current file list and said previous file list;
generating a difference list listing said files that have changed between said current file list and said previous file list.

14. A client computer comprising:
a data processor;
a data storage device having a data storage area reserved for files which are subject to a back-up process;
an interface device; and
a back-up management agent which operates to manage back-up of files in said backed-up data storage area by sending said files via said interface device, wherein said client management agent operates to receive a first quota limit from an external source, said first quota limit describing an amount of data storage capacity which said client computer is permitted to maintain in said backed-up data storage area.

15. The client computer as claimed in claim 14, wherein said client management agent operates to receive a second quota limit from an external source, said second quota limit describing an amount of data storage capacity which said client computer is permitted to maintain in said backed-up data storage area.

16. The client computer as claimed in claim 14, wherein said client management agent operates to:
maintain a quota list, describing an amount of data allowed to be stored in said backed-up data storage area;
a file list describing one or more files currently stored in said backed-up data storage area;
a previous file list, describing a plurality of files previously stored in said backed-up data storage area immediately prior to a last back-up operation carried out by said client management agent; and
a difference list storing data describing differences between files on said new file list, and files on said previous file list.

17. A method of performing back-up of data on a back-up computer, said method comprising the steps of:
each time a back-up operation of said client computer is initiated, determining a total size of all files of said client computer to be backed up, and determining whether performance of said back-up would cause a first predetermined quota limit to be exceeded;
determining if performance of said back-up would cause a second predetermined quota limit to be exceeded;
if it is determined that performance of said back up would cause said first predetermined quota limit to be exceeded, but said second predetermined quota limit not to be exceeded, then proceeding with said back-up, and generating a warning signal warning that said first predetermined quota limit is exceeded; and
if performance of said back-up would exceed said second predetermined quota limit, then prohibiting said back-up, and generating a warning signal that said second predetermined quota limit would be exceeded.

18. A method of operating a client computer, said client computer comprising;
a data storage device for storing client files, said data storage device having a back-up data storage area from which files may be sent for back-up; and
a back-up management agent for managing back-up of data from said backed up data storage area;
said method comprising the steps of:
upon initiation of a back-up process;
maintaining a quota list, said quota list comprising a list of files in said backed-up area, which were backed up during a previous back-up operation;
performing a back-up operation on said files stored in said backed up data storage area;
after said back-up operation, modifying said copy quota list to list a plurality of files actually backed up by said back-up operation.

19. The method as claimed in claim 18, further comprising the steps of:
producing a modified quota list to comprising a list of files currently in said backed up data storage area; and
determining from said modified quota list, whether performance of a back up operation is within a quota limit.

20. The method as claimed in claim 18, wherein said step of producing a modified quota list comprises:
generating a difference list, said difference list listing details of files which are difference between a current content of said backed up data storage area, and said quota list.
